(19) United States
(12) Patent Application Publication
(10) Pub. No.: US 2021/0209307 A1
(43) Pub. Date: Jul. 8, 2021

(54) INTERACTIVE VISUAL DASHBOARD FOR IMPLEMENTING SENTIMENT ANALYSIS BASED ON SOCIAL MEDIA DATA

(71) Applicant: Bank of America Corporation, Charlotte, NC (US)

(72) Inventor: Daniel J. Serna, The Colony, TX (US)

(21) Appl. No.: 16/732,472

(22) Filed: Jan. 2, 2020

(51) Int. Cl. G06F 40/30; G06F 9/54; G06F 16/2458; H04L 12/58; G06F 40/295

(52) U.S. Cl. CPC G06F 40/30; G06F 9/54; G06F 16/2465; H04L 51/32; G06N 20/00; H04L 51/046; G06F 40/295; G06F 2216/03; H04L 51/22

(57) ABSTRACT

Methods for augmenting a positive sentiment trend or mitigating a negative trend are provided. Sentiment trend may be derived from a sentiment analysis. Sentiment analysis may be based on aggregating communications between a first individual, group or entity and a second individual, group or entity. Sentiment analysis may include mining social media to recover a plurality of artifacts. Each of the artifacts may include a transmitting entity and a receiving entity. Methods may include identifying a transmitting entity of the artifact; identifying a receiving entity; and adding the sentiment score to an aggregated sentiment score. Aggregated sentiment score may be associated with a communication link. The sentiment score may repeatedly generate, over a pre-determined amount of time, an aggregated sentiment score for the communication link; identify a positive trend in the aggregated sentiment score; and trigger an augmenting response to the positive trend.

### FIELD OF TECHNOLOGY

This disclosure relates to sentiment analysis.

### BACKGROUND OF THE DISCLOSURE

Individuals, groups and/or entities typically generate and receive messages. Each of the messages typically includes some level of sentiment. Such sentiment, and shifts in the sentiment from positive to negative and negative to positive, can be analyzed to help mitigate the effects of such shifts and/or to augment the benefits coincident with such shifts.

The following paragraphs provide one example of the importance of recognizing sentiment. Large/global organizations often rely on an operation model in which teams or vendors provide value as-a-service to a critical component of the organization. For instance, many organizations rely on vendors to provide a tool or people for management of payroll and employee benefits. Vendor management is a discipline that enables financial services companies to control costs, drive service excellence, mitigate risks, and gain increased value over the life cycle of supplier relationships. The premium placed on transparency, uniformity, and open participation in government contracting, however, increases bureaucracy associated with the interaction with such vendors. This bureaucracy often requires decoding, increases consumption of time and resources and creates inefficiencies.

Onboarding vendors also creates difficulties for large entities. In fact, it often takes more than three months to onboard a vendor—i.e., to get a master services agreement (MSA) in place. This discourages business units from exploring new capabilities and service providers, because it takes too long to get vendors “onboarded”—i.e., initially contracted to the organization to produce goods and/or services. Also, there may be no feedback loop on price, scope, and the refining of contract terms prior to closing such an onboarding agreement. This reduces vendor responsiveness in making adjustments. Such unrealized adjustments may have obtained higher vendor product quality for an improved (though not necessarily lowest) price.

Since the advent of the digital world, the internet has provided and continues to provide a source of opinion-based information. This information may be culled from a variety of internet channels in which an entity may voice an opinion. Such internet channels may include blogs, emails, social media, chats, text messaging, message services or any other suitable opinion-voicing channel. Because of the ease associated with providing opinions, testimonials and comments on the internet, there has been a proliferation of written opinions available regarding a wide variety of topics.

Opinion-based information is used by various industries for a variety of purposes. Opinions may be used to understand the public's attitude towards a product, company or relationship. Public discourse in online sources, such as social media, may be correlated with the occurrence of real-world behavior.

It would be desirable to analyze the sentiment of publicly available opinion-based data to provide predictive indicators of threats and/or cyberattacks.

It would be further desirable to analyze the sentiment of publicly available opinion-based data to detect and remediate difficulty or ease in the communications between groups within an organization.

It would be yet further desirable to analyze the sentiment of publicly available opinion-based data to optimize communications between separate organizations.

It would be still further desirable to present a color-coded dashboard that culls information from third party opinion-based sources and uses the culled information to provide a color-coded dashboard that dynamically responds to real-time changes in user sentiment.

### SUMMARY OF THE DISCLOSURE

A method for determining a negative sentiment trend is provided. The determining may include aggregating the sentiment analysis of communications between a plurality of individuals, groups or entities. The method may include identifying two individuals, groups or entities. The method may further include identifying a communication link. The communication link may exist between the two individuals, groups or entities. The communication link may be associated with an individual aggregated sentiment score.

The method may further include mining a plurality of artifacts. Each artifact may be included in a plurality of artifacts being transmitted between the two individuals, groups or entities. The method may also include determining a sentiment score for each of the plurality of artifacts, and then labeling each artifact with the sentiment score; the individual, group or entity from which the artifact was transmitted; and the entity to which the artifact was transmitted.

In response to receipt of each artifact, the method may also include updating an aggregated sentiment score that corresponds to the communication link and periodically updating, over a pre-determined amount of time. The aggregated sentiment score for the communication link. The method may also include identifying a negative trend in the aggregated sentiment score over the pre-determined amount of time; and triggering, based at least in part on the identifying a negative trend, a mitigating response to the negative trend in the aggregated sentiment score.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative database diagram in accordance with principles of the disclosure;

FIG. 2 shows an illustrative diagram in accordance with principles of the disclosure;

FIG. 3 shows another illustrative diagram in accordance with principles of the disclosure;

FIG. 4 shows yet another illustrative diagram in accordance with principles of the disclosure;

FIG. 5 shows still another illustrative diagram in accordance with principles of the disclosure;

FIG. 6 shows yet another illustrative diagram in accordance with principles of the disclosure;

FIG. 7 shows still another illustrative diagram in accordance with principles of the disclosure;

FIG. 8 shows yet another illustrative diagram in accordance with principles of the disclosure;

FIG. 9 shows an illustrative dashboard in accordance with principles of the disclosure;

FIG. 10 shows an illustrative flow diagram in accordance with principles of the disclosure; and

FIG. 11 shows another illustrative flow diagram in accordance with principles of the disclosure.

### DETAILED DESCRIPTION OF THE DISCLOSURE

A system for analyzing aggregated sentiment is provided. The aggregation may be based on communications associated with a number of individuals within a group/team, within an entity or a vendor associated with the entity. The aggregated sentiment may enable retrieval of useful information about a team/group. The system may mine emails, Instant Messaging Service (IMS) or other suitable communication media, such as social media, to detect difficulty and/or negative connotation against a specific individual, team, or group or within the entity. The negative connotation may help, in certain circumstances, detect an imminent threat based on the sentiment.

Certain embodiments of systems and methods according to the disclosure may be limited to group analysis and not individual analysis (in part because of privacy concerns). Some embodiments of systems and methods according to the disclosure may involve analysis of individual communications, group communications and/or entity communications.

A system to quantify effectiveness and levels of satisfaction of relationships of groups using aggregated sentiment analysis is provided. Communication artifacts (i.e. email, Instant Messaging Service (IMS), phone calls, video chats) and other elements (e.g., response time, escalations, etc.) may be analyzed to define the sentiment of the interactions of an individual, group and/or entity towards one or more individuals, groups and/or entities.

Compiling and aggregating sentiment may provide some or all of the following information: effectiveness of a recent reorganization of an enterprise's teams, competence and/or effectiveness of a new vendor, identification of the intent behind the propagation of sensitive or misleading information among teams, and/or communications between an individual on one side and an individual, group and/or entity on the other side.

Along these lines, the internet has developed as a rich source of opinion-based information. This information has been used in various industries for different purposes. However, the mining of publicly-available data has become more complex because of the proliferation of false information. Opinions, testimonials, and comments that are “bot”-generated, or falsified by organizations have made statistical data less relevant and not reflective of the true opinions and concerns of the public. Nonetheless, it is still desirable to use sentiment analysis to learn about opinions, as these might be indicative of reputational threats, spread of misinformation, and indicators of future trends.

Certain use cases illustrate how some embodiments substantially minimize or avoid the aforementioned problem of false information. For example, analyzing insiders within an entity on a group level as opposed to on an individual level (protecting an individual's privacy) may reduce the effect of false information because insider information tends to be more truthful.

In another use case, analyzing messaging using sentiment analysis within the group to detect sarcasm, negativity, and threat by mining publicly available data of individuals, employees/groups and/or entities can identify a morale of individuals, groups and teams within the entity. Such analyzing can monitor and rate the positive and negative sentiment of customer satisfaction in association with the group, or, alternatively, two different teams within the entity's collaboration.

Moreover, evidence suggests that public discourse in online sources, such as social media, is strongly correlated with the occurrence of real-world behavior. This same premise can provide predictive indicators of cyberattacks, and is, at least in part, a focus of this disclosure. For example, extreme negative sentiments towards an organization may indicate a higher probability that it will be the target of a cyberattack.

Data gathered from online platforms such as Twitter™ has the potential to facilitate research regarding social phenomena based on sentiment analysis. Such research typically usually employs natural language processing and machine learning (ML) techniques to interpret sentimental tendencies related to users' opinions. Such research may make predictions about real events, and may utilize methods to mitigate negative trending and/or to enhance or augment positive trending.

For example, cyber threats are hard to accurately predict because attackers usually try to mask their traces. However, attackers often discuss exploits and techniques on hacking forums. The community behavior, and sentiment, of the hackers may provide insights into groups' collective malicious activity.

With advances in the technical capabilities of Internet of Things (IoT) devices, insider threats are becoming more dangerous. In response, embodiments may utilize one or a combination of social media data, sentiment analysis libraries, and business intelligence tools to create an interactive dashboard. At least one purpose of such a dashboard may be to monitor and address changing customer sentiment.

In certain embodiments, social media data is retrieved using publically-available APIs (“Application Programming Interfaces” such as the Twitter™ API.) This data may then be parsed and transformed into structured data which is then stored in a database. For the purposes of this disclosure, at least the following data points may be tracked: date, time, location username and message.

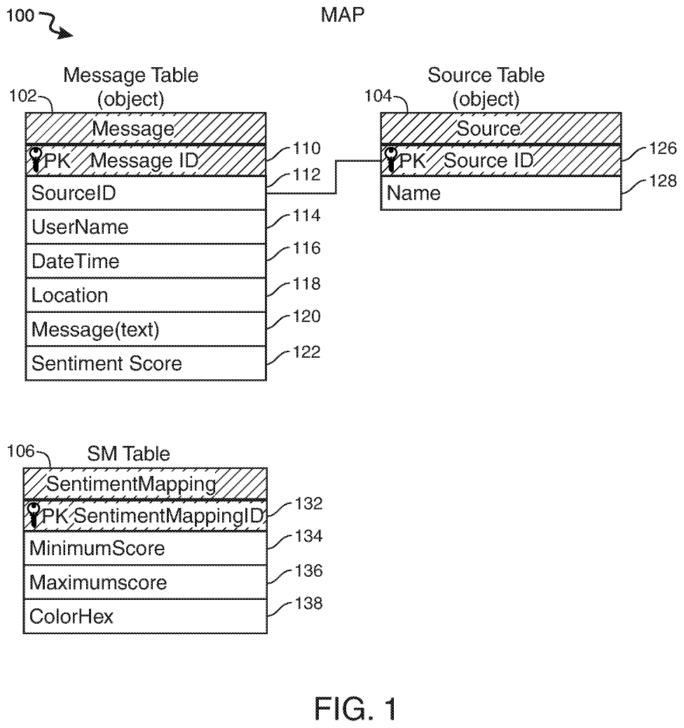

Once social media data has been retrieved, it can be parsed for sentiment analysis utilizing any number of libraries such as the Natural Language Toolkit sentiment library. The resulting sentiment score may be stored in a column in a table (see, e.g., sentiment mapping table 106 in FIG. 1, described in more detail below) tied to the relevant record. At least one end goal is to color code sentiment for visual analysis in a dashboard.

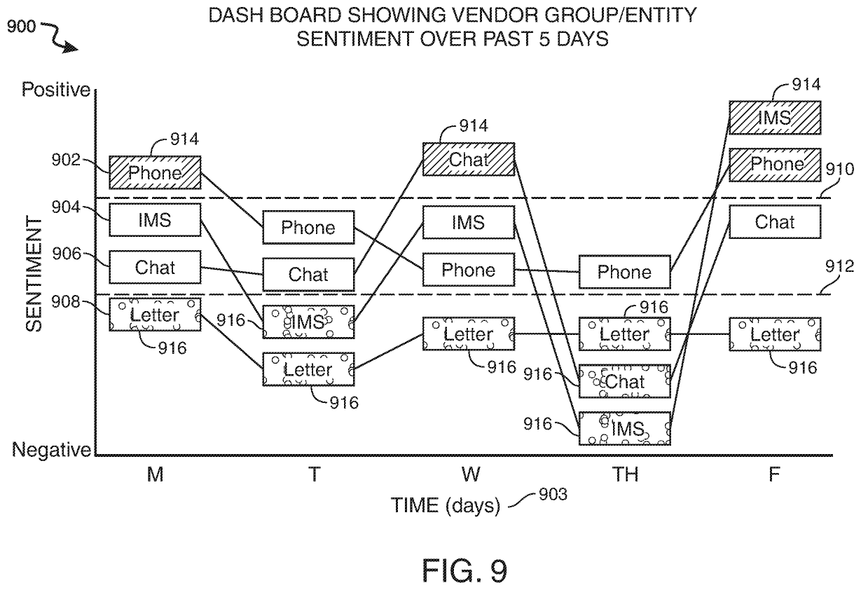

In addition, an internal mapping of sentiment scores to color can be maintained for use in a dashboard (see, e.g., color hex 138 in FIG. 1). A minimum score column 134 and a maximum score column 136 in the sentiment mapping table may be implemented as follows. Those columns can be used to determine the sentiment score range associated with a color. For example, a score of 1 to 10 might be tied to red and 90-100 might be tied to green. Such a dashboard, as shown for example in FIG. 9, may be used to trigger responses to alert conditions detected in the internal mapping. Such responses may be expressed, for example, by the color, or pattern, of the display of the alert condition artifacts.

In certain embodiments of such a dashboard, a high sentiment score (typically positive sentiment) is associated with the color green while low sentiment score (typically negative sentiment) is associated with the color red. A full color spectrum mapping may be used in order to categorize a large range of possible sentiments

FIG. 1 shows a possible database implementation of a system according to the invention. Specifically, FIG. 1 shows an entity relationship map 100 for customer sentiment. While map 100 relates to customer sentiment, it should be noted that map 100 could be used to illustrate any suitable relationship sentiment according to the embodiments set forth herein.

Message 102 (which is in the form of a table which is a database object) contains various attributes relating to the message. The exemplary information included in message table 102 is a message ID 110, source ID 112, username 114, date/time 116, location 118, message (text) 120, and/or sentiment score 122.

Message ID 110 is the primary key for message table 102. As such, message ID 110 represents the only necessarily unique attribute of message 102.

Source 104 (which is also in the form of a table) provides attributes regarding the source ID. Attributes for source 104 include source ID 126 and name 128. Source ID 126 is the primary key for source 104. As such, source ID 126 represents the only necessarily unique attribute of source 104.

Sentiment mapping 106 (which is also in the form of a table) provides attributes regarding the formation and utilization of the sentiment score. Attributes for sentiment mapping 106 include sentiment mapping ID 132, minimum score 134, maximum score 136 and colorhex 138. Sentiment mapping ID 132 is the primary key for sentiment mapping 106. As such, sentiment mapping ID 132 represents the only necessarily unique attribute of sentiment mapping 106.

After sentiment analysis has been performed, the data is ready to be consumed and displayed in a dashboard. Any number of existing platforms can be used to display the color-coded sentiment data points. For example, a geographical map may be used to display the color-coded sentiment data points. This color-coding enables users to monitor changing sentiment trends across one or more pre-determined regions. This color-coding also enables users to address issues causing shifts to negative sentiments. Drill-down functionality may also be provided in order to enable users to focus on areas with negative sentiment for more in-depth analysis and/or to trigger targeted responses to such sentiment.

The tables described above in FIG. 1 may be leveraged, in some embodiments, as follows: message 102 may preferably include a message. Source ID 104 may preferably include lineage information relating to the data in the message. Sentiment mapping 106 may preferably include information regarding how to map the sentiment to a dashboard and/or to a triggering device. The triggering device (not shown) may preferably monitor the information and trigger a trend mitigation (to offset a negative trend) or trend augmentation (to enhance a positive trend) response when instructed.

Some embodiments present a visual dashboard to monitor customer sentiment gathered from social media data. Social media data sets are typically extremely large and unstructured. The large size and lack of structure can make social media data sets challenging to analyze and manipulate through traditional methods. A visual interface accordingly to the embodiments simplifies analysis and enables users to more quickly address shifts to negative sentiment. Further—the visual interface can be used to automatically trigger response(s) to such detected sentiment(s) or sentiment trends. Such responses may remediate alert conditions and/or correct sentiment issues preferably simultaneously to the display of such conditions. Such responses may alternatively include augmenting positive results obtained from shifts to positive sentiment.

Also, in the event that the communications between a first individual, group or entity and a second individual, group or entity is more positive than the communications between the first individual, group or entity and a third individual, group or entity, collaboration between the first individual, group or entity and the third individual, group or entity may be halted or decreased.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

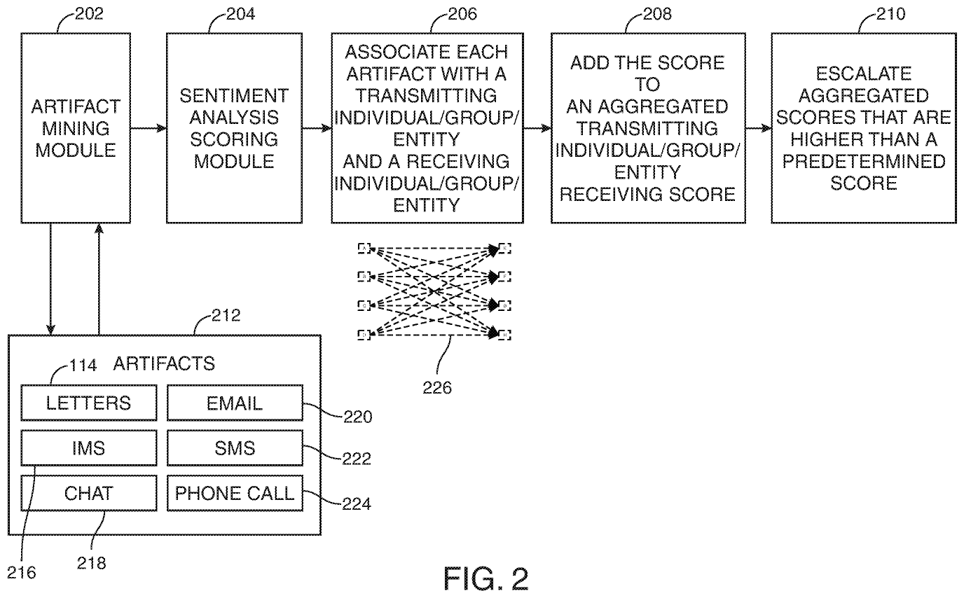

FIG. 2 shows an illustrative diagram. Artifact mining module, shown at 202, may mine a plurality of artifacts, as shown at 212. The plurality of artifacts may include letters 214, IMS 216, chat 218, email 220, SMS (“Short message service”) 222 and phone call 224.

Upon retrieval of one or more artifacts by artifact mining module 202, sentiment analysis scoring module 204 may analyze each of the artifacts. The artifacts may be analyzed based on a variety of different scoring models. The variety of different scoring models may include a polarity-based scoring model, a multi-dimensional vector-based scoring model and a two-dimensional scoring model. The different scoring models will be described in greater detail below.

The sentiment analysis scoring module may determine a score for each artifact. The score may be a composite score retrieved from numerous scoring models. The score may be a single number score. The score may be a vector.

Upon determination of a score for each of the artifacts, a transmitting entity group and a receiving entity group may be determined for each artifact. It should be appreciated that the score determination may occur prior to, simultaneous to or after the transmitting/receiving entity group determination.

Each artifact may be associated with a transmitting individual, group and/or entity and a receiving individual, group and/or entity, as shown at 206.

There may be an optional graph that shows communications between entities. For example, in a group of 100 entities, 50 of them may be determined to be transmitting entities in such a graph and 50 of them may be determined to be receiving entities in such a graph. The communications between the entities may optionally be shown, for example in a dashboard, as lines across the graph, as shown at 226.

In other embodiments, the communication graph may be circular. In such a communication graph, it may be apparent that no specific entity is a transmitting entity and no specific entity is a receiving entity. Each entity can be both a receiving entity and a transmitting entity. Although a horizontal-type graph shows that as well, it becomes clearer in a circular type graph.

After a transmitting entity and a receiving entity are determined, a communication link may be determined. The communication link may link the transmitting entity to the receiving entity. The communication link may be associated with an aggregated score. The aggregated score may be an aggregated sentiment score of all communications between the transmitting entity and the receiving entity. Upon determination of the communication link, the determined score may be added to the aggregated score in order to update the aggregated score. The aggregated score may be updated to reflect the latest artifact. The score may be added to an aggregated transmitting individual, group and/or entity-receiving score, as shown at 208.

It should be appreciated that, at times when there are many artifacts included in the aggregated score, each inputted artifact may change the aggregated score slightly because a single artifact within a plurality of many artifacts only changes the average score slightly. As such if there are only a few artifacts used to create an aggregated score, each inputted artifact may make a significant change in aggregated score.

It should be further appreciated that the score of an artifact being inputted into the aggregated score can be done in multiple approaches. One approach may be that the score is weighted based on the number of artifacts already included in the aggregated score. This way ensures that the score does not have to be averaged each time a new artifact is received. Also, this approach allows the artifacts and their scores to be archived as soon as the artifact is entered into the average.

In another approach, the artifact and its score are maintained and the average is completely re-executed each time a new artifact is received.

Scores may range from healthy and productive environment scores to non-healthy and detrimental environment scores. Scores that are greater than a predetermined score—i.e., scores that indicate an environment that may be non-healthy and detrimental may be escalated or weighted, as shown at 210. There may be various remediation measures that may be implemented to lower the score between two entities. The measures may include halting communications between the entities, redirecting communications between the entities to an intermediary and any other suitable remediation measures.

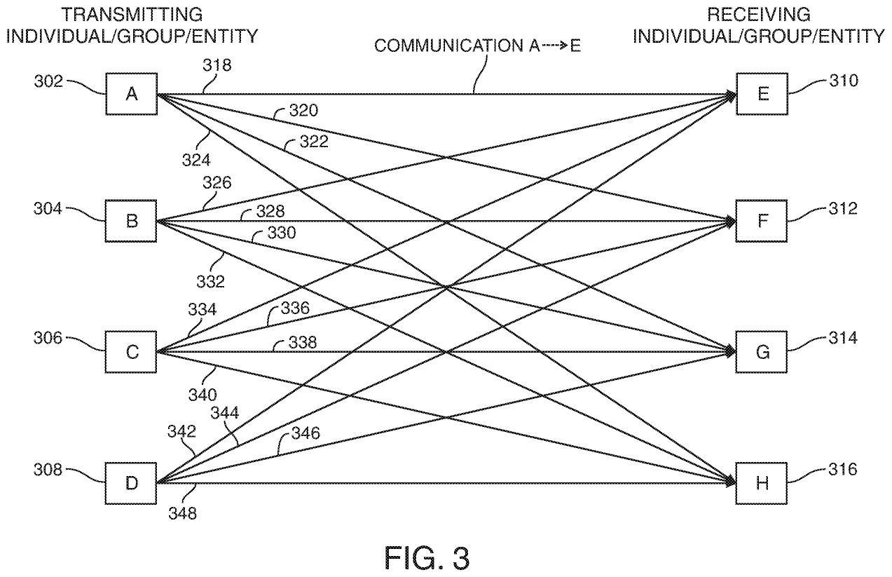

FIG. 3 shows an illustrative communications map. The illustrative communications map may include a variety of individuals, groups and/or entities. The individuals, groups and/or entities shown include entity A (shown at 302), entity B (shown at 304), C (shown at 306), D (shown at 308), E (shown at 310), F (shown at 312), G (shown at 314) and H (shown at 316).

Individuals, groups and/or entities A, B, C and D are shown as transmitting individuals, groups and/or entities. Individuals, groups and/or entities E, F, G and H are shown as receiving individuals, groups and/or entities. In some embodiments, an individual, group and/or entity may be defined as a transmitting individual, group and/or entity or a receiving individual, group and/or entity. In certain embodiments, an individual, group and/or entity may be considered both a transmitting individual, group and/or entity and a receiving individual, group and/or entity.

Each individual, group and/or entity may be in communication with one or more of the other individuals, groups and/or entities. The communications may be conducted over communication lines. The communication lines may be virtual communication lines, wired communication lines, wireless communication lines, communication lines that utilize a network or any other suitable communication lines.

Each communication line shown may connect two or more individuals, groups and/or entities. It should be appreciated that, although the communication lines shown connect A, B, C and D to E, F, G and H, there may be additional communication lines that are not shown. In some embodiments, communication lines may enable communication between A, B, C and D, and between E, F, G and H.

Each communication line may enable one-way or two-way communications. Communication lines that enable one-way communication may push communications from a first individual, group or entity to a second individual, group or entity. Communication lines that enable two-way communications may push communication from a first individual, group or entity to a second individual, group or entity, and from the second individual, group or entity to the first individual, group or entity. Communication lines that are one-way may be parallel to a second communication line that enables the reverse of the one-way communication line. For example, if a first communication line enables one-way communication between entity group A and entity group E, a parallel communication line may enable one-way communication between entity group E and entity group A.

Communication lines shown may include 318 (A-E), 320 (A-F), 322 (A-G), 324 (A-H), 326 (B-E), 328 (B-F), 330 (B-G), 332 (B-H), 334 (C-E), 336 (C-F), 338 (C-G), 340 (C-H), 342 (D-E), 344 (D-F), 346 (D-G) and 348 (D-H).

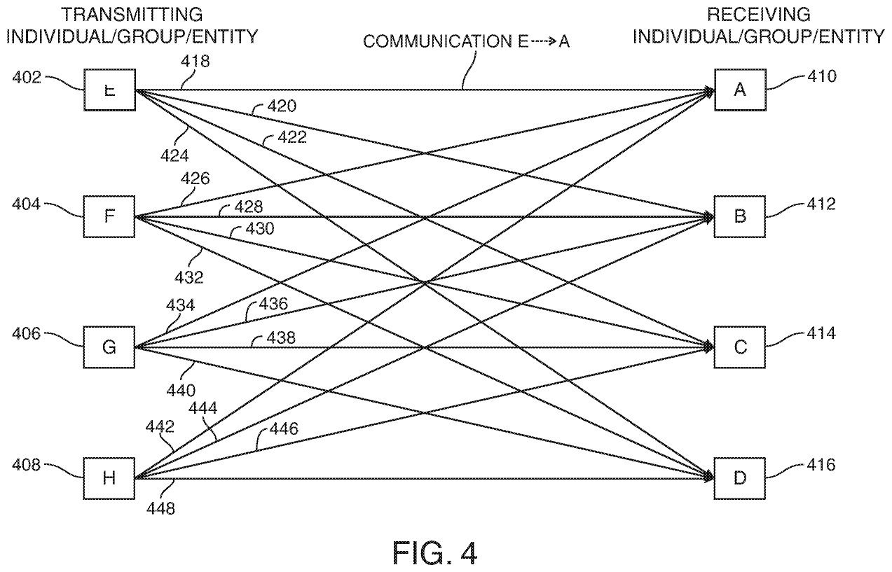

FIG. 4 shows another illustrative communications map. The communications map may show individual, group or entity E (shown at 402), individual, group or entity F (shown at 404), individual, group or entity G (shown at 406) and individual, group or entity H (shown at 408) communicating with individual, group or entity A (shown at 410), individual, group or entity B (shown at 412), individual, group or entity C (shown at 414) and individual, group or entity D (shown at 416).

Each communication line shown may connect two or more entity groups. It should be appreciated that, although the communication lines shown connect individuals, groups or entities E, F, G and H to individuals, groups or entities A, B, C and D, there may be additional communication lines that are not shown. In some embodiments, communication lines may enable communication between individuals, groups or entities E, F, G and H, and between individuals, groups or entities A, B, C and D.

Each communication line may enable one-way or two-way communications. Communication lines that enable one-way communication may push communications from a first individual, group or entity to a second individual, group or entity. Communication lines that enable two-way communications may push communication from a first individual, group or entity to a second individual, group or entity, and from the second individual, group or entity to the first individual, group or entity. Communication lines that are one-way may be parallel to a second communication line that enables the reverse of the one-way communication line. For example, if a first communication line enables one-way communication between individual, group or entity A and individual, group or entity E, a parallel communication line may enable one-way communication between individual, group or entity E and individual, group or entity A.

Communication lines shown may include 418 (E-A), 420 (E-B), 422 (E-C), 424 (E-D), 426 (F-A), 428 (F-B), 430 (F-C), 432 (F-D), 434 (G-A), 436 (G-B), 438 (G-C), 440 (G-D), 442 (H-A), 444 (H-B), 446 (H-C) and 448 (H-D).

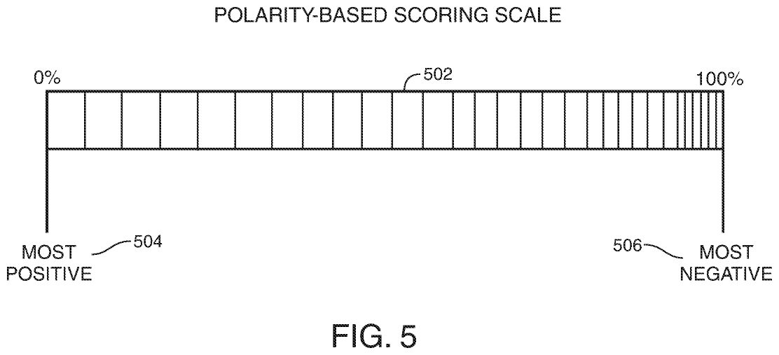

FIG. 5 shows an illustrative scoring scale. There may be various different methods or scales for scoring artifacts as part of an aggregate score. For example, an artifact may be scored based on positive or negative sentiment. An artifact may be scored based on polar emotions, such as happy or sad. An artifact may be scored in a non-polar scale, such as a vector scaling model. An artifact may be scored on a collection of multiple sentiment scoring methods or models.

Polarity-based scoring scale 502 is shown in FIG. 5. In such a scoring scale, each artifact is scored on a polar scale using linguistic scoring methodology. Linguistic scoring methodology may utilize various language scoring methods, such as natural language processing, computational linguistics and biometrics. The language scoring methodology may also include text analysis. The text analysis may analyze various components of the text. It should be appreciated that, to a human reader, certain text components, such as sarcasm, exaggerations or jokes may be easily understood. However, a computer may require special methods to ensure that such linguistic terms are not misinterpreted. Therefore, the text analysis may analyze key words and phrases, emoticons, characters, length of response, response time between artifacts, related artifacts, negation, exaggeration, jokes and sarcasm. Based on the linguistic scoring methodology, each artifact may be scored on a scale of 0% to 100%, as shown at 504 and 506. 0% may indicate most positive and 100% may indicate most negative.

It should be appreciated that a polarity-based scale may include two opposite emotions, whether positive and negative, happy and sad or any other suitable opposite emotions. Therefore, each artifact scored on a polarity-based score may only be given a score based on the polarity of the artifact. However, at times, in order to compensate for the shortcomings of the polarity-based scoring models, an artifact may be scored on multiple polarity-based scoring models, and, the results of the scoring models may be combined.

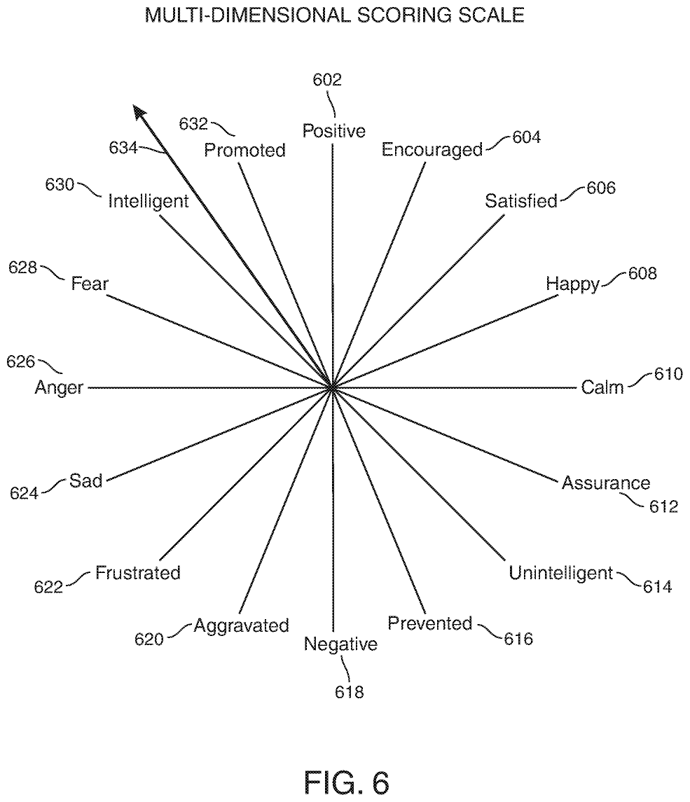

FIG. 6 shows a multi-dimensional scoring scale. The multi-dimensional scoring scale may include a plurality of vectors. Each of the vectors may correspond to a different emotion or sentiment. The emotions, or sentiments shown, may include positive (602), encouraged (604), satisfied (606), happy (608), calm (610), assurance (612), unintelligent (614), prevented (616), negative (618), aggravated (620), frustrated (622), sad (624), anger (626), fear (628), intelligent (630) and promoted (632).

Vector 634 may be a vector generated from an artifact. The artifact may include a plurality of attributes. The artifact may be broken down into component parts. The attributes and the component parts may be used to plot the artifact on the multi-dimensional scoring scale.

The sentiment of the artifact plotted as vector 634 may be shown in-between intelligent and promoted. It should be appreciated that the multi-dimensional scoring scale may be used to determine the sentiment of an artifact. The multi-dimensional scoring scale may include a plurality of other emotions, not shown. In some embodiments, the multi-dimensional scoring scale may utilize any suitable emotion chart.

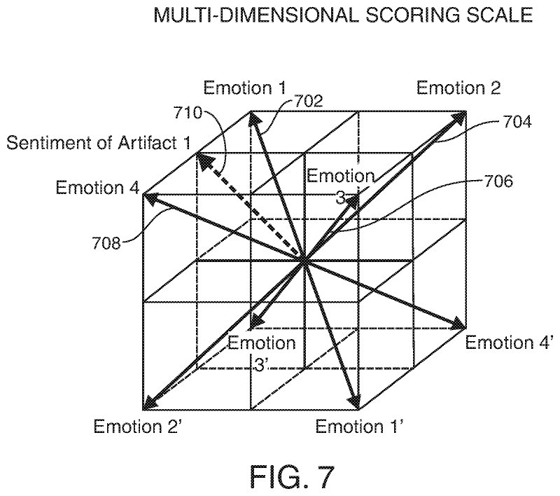

FIG. 7 shows another multi-dimensional scoring scale. The multi-dimensional scoring scale may be three-dimensional. The three-dimensional scoring scale may include an x-dimension (horizontal), a y-dimension (vertical) and a z-dimension (depth). Vectors that represent emotions may be plotted on the three-dimensional scoring scale.

A vector may have multiple dimensions, such as an x-dimension, a y-dimension and a z-dimension. As such, a vector may be plotted on the three-dimensional scoring scale that comprises an x-dimension, y-dimension and z-dimension. Each plotted emotion may be represented by a vector, such as vector 702 that represents emotion 1, vector 704 that represents emotion 2, vector 706 that represents emotion 3 and vector 708 that represents emotion 4.

Build of a vector, or orientation of a vector, could be based on one or more of a combination of sentiments or emotions. In some embodiments, vector length could correspond to magnitude or intensity of a vector.

Each plotted vector that represents an emotion may have two extremes. For example, a vector may represent a range of happiness and sadness. Each point of the vector may represent a different extreme in the range of happiness and sadness. At the (0,0,0) point, the vector may represent neutrality (neither happy nor sad). Location points found on the vector above the (0,0,0) point may represent a gradually increasing degree of happiness, while location points found below the (0,0,0) point may represent a gradually increasing degree of sadness.

Upon the receipt of an unlabeled artifact, the artifact may be broken down into component parts. The component parts may be used to generate a vector. The vector may be plotted on a multi-dimensional scoring scale, such as the one shown in FIG. 7. Such a vector may be shown at 710. Vector 710 may represent the sentiment of artifact 1. Because sentiment of an artifact may be multi-faceted—i.e., may include multiple emotions—vector 710 may represent the sentiment of artifact 1 with respect to the emotion vectors.

In some embodiments, the emotion vector, or vectors, that most closely represents the sentiment of the artifact may be displayed to a user. In certain embodiments, a detailed score comprising the various components of the artifact may be shown. For example, an artifact may be determined to include 20% happiness, 40% kindness, 30% caring and 10% consideration. For such an artifact, the entire breakdown may be shown and/or the single most dominant attribute—kindness may be shown. In some embodiments, the only displayed sentiment may be positive or negative.

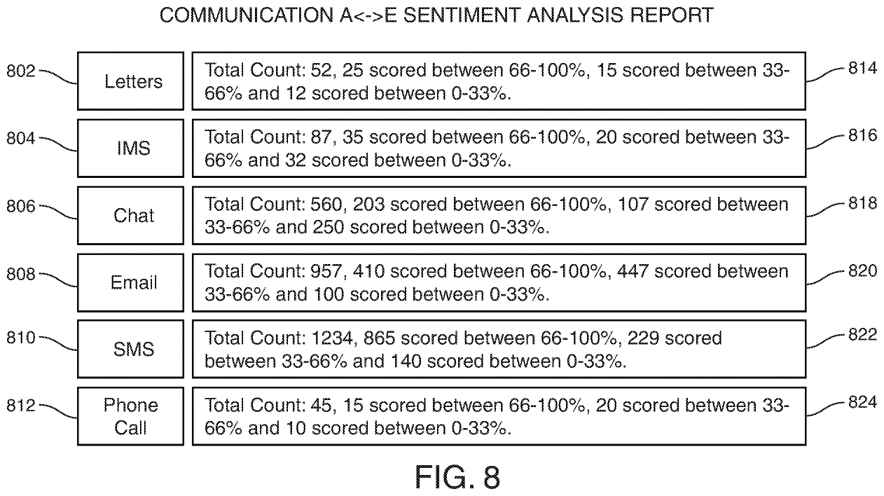

FIG. 7 shows an exemplary sentiment analysis report. The exemplary sentiment analysis report may be for communications between entity groups A and E. In the sentiment analysis report shown, the various categories of communications may be analyzed separately. The categories shown may include letters (802), IMS (804), chat (806), email (808), SMS (810) and phone call (812). The analysis for each of the categories may be shown at 814 (letter analysis), 816 (IMS analysis), 818 (chat analysis), 820 (email analysis), 822 (SMS analysis) and 824 (phone call analysis). It should be appreciated that the analysis shown in FIG. 8 may be based on a polarity-based scoring model, however, any suitable scoring model may be used to generate an analysis.

In some embodiments, different communication types may be weighted differently—i.e., not all communications may carry the same weight.

Such a sentiment analysis report may be useful in determining which category of communication is most effective between two individuals, groups and/or entities. Specifically, if one communication mode is more effective than another communication mode—i.e., a first communication mode is determined to include significantly more positive communications than a second communication mode—appropriate remediation measures may be instituted to encourage the use of the more effective communication mode.

FIG. 9 shows an exemplary dashboard 900 showing vendor group/entity sentiment over a five-day period. It should be noted that, in exemplary dashboard 900, sentiment represents the x-axis 901 and time represents y-axis 903. It should also be noted that while dashboard 900 is directed to a vendor group/entity relationship, a dashboard displaying any combination of a relationship including a first individual, group or entity and a second individual, group or entity, and any suitable combination thereof, is within the scope of this disclosure.

Dashboard 900 plots sentiment associated with phone 902, IMS 904, chat 906 and letter 908 over a five-day period. Dashboard 900 also shows a pre-determined positive sentiment line at 910 and a pre-determined negative sentiment line at 912. Anything over positive sentiment line 910 may be indicated by a first visual indicator, such as hatching at 914. Anything under negative sentiment line 912 may be shown by a second visual indicator such as, for example, bubbles 916. In this way, a viewer can easily determine the current state, as well as the trend, of some or all of the sentiment related to the relationship being displayed.

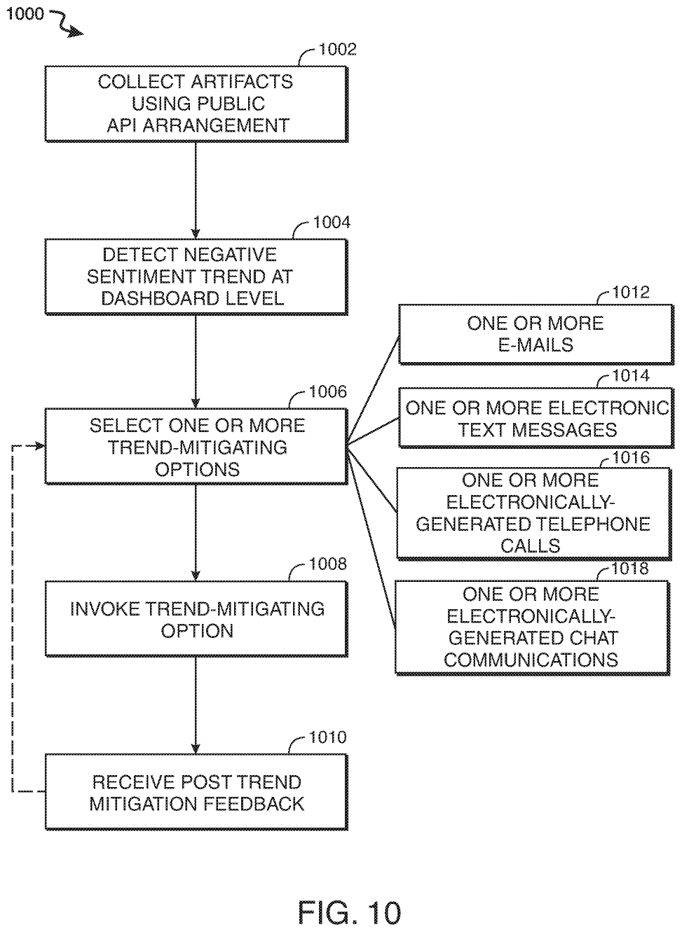

Moreover, dashboard may be used to trigger sentiment trend mitigation responses. For example, FIG. 10 shows a first illustrative flow diagram 1000 for detecting a negative trend and responding thereto. First illustrative flow diagram 1000 may utilize a public API or other device to collect artifacts, as shown at 1002.

Based on this information, first illustrative flow diagram 1000 may detect a negative sentiment trend, as shown at 1004. It should be noted that this detection may occur at the dashboard level, or using a dashboard. In any case, flow 1000 may exist with or without dashboard utilization.

At step 1006, flow 1000 may include auto-selecting, in response to detection of a negative sentiment trend at 1004, one or more trend-mitigating options. Such selection may be based on machine learning (ML) that is based on the success or failure of historical trend mitigating options. Furthermore, such selection can be tuned, as set forth in more detail below with regards to the portion of the specification relating to post trend mitigation feedback 1010.

Such trend-mitigating options may include transmission of one or more e-mails (to relevant parties) 1012, transmission of one or more electronic-text messages (to relevant parties) 1014, transmission of one or more electronically-generated telephone calls (to relevant parties) 1016 and transmission of one or more electronically-generated chat communications (to relevant parties) 1018. Such transmission, w/trend-mitigating messaging, may serve to offset other trend-causing stimuli.

Thereafter, flow 1000 may include invoking trend-mitigating option 1008. Following invocation of trend-mitigating option 1008, flow 1000 may include receiving post trend mitigation feedback, as shown at 1010. Such feedback 1010 may be used to select one or more additional trend-mitigating options as shown at 1006 in an additional round(s) of trend mitigation. It should be noted that ML may be used to select which option should be used to further mitigate. For example, trend-mitigating text-messaging may be invoked when an immediate trend-mitigation response is called for.

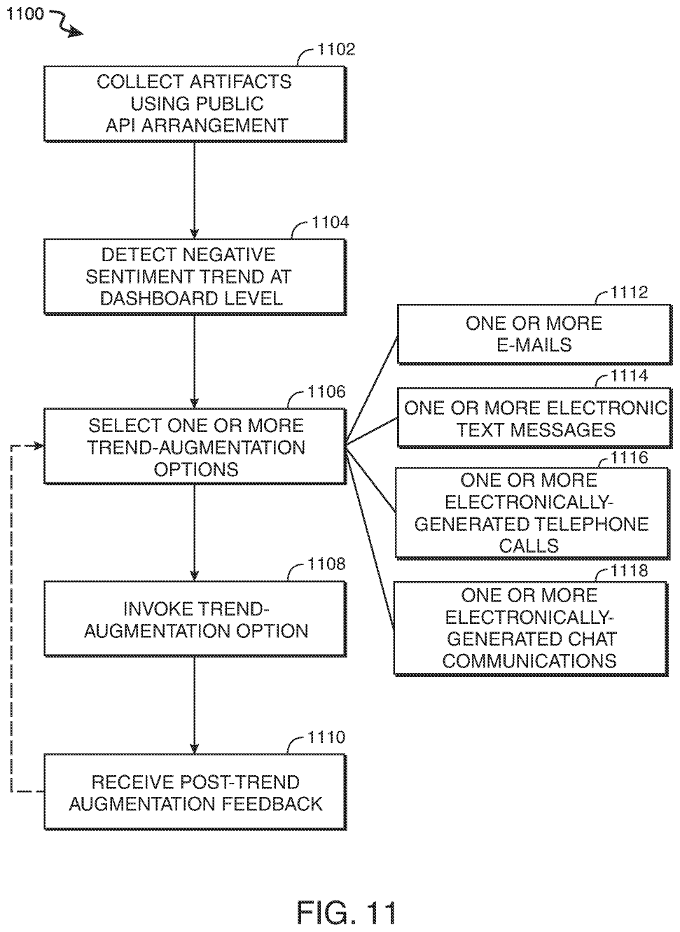

FIG. 11 shows a flow diagram similar to the flow diagram shown in FIG. 10. The difference between flow 1100 shown in FIG. 11 and flow 1000 shown in FIG. 10 is that flow 1100 is for augmenting positive trending sentiment, while flow 1000 is for mitigating the effects of negative-trending sentiment. It should be noted, however, that steps 1102, 1104, 1106, 1108 and 1110 substantially mirror steps 1002, 1004, 1006, 1008 and 1010 albeit in the augmentation of positive-trending sentiment instead of mitigating negative-trending sentiment. It should also be noted that exemplary augmentation options 1112, 1114, 1116 and 1118 substantially mirror mitigation options 1012, 1014, 1016 and 1018. It should be noted, however, that the methods for mitigating negative trends may be the same or different from the methods for augmenting positive trends.

Thus, an aggregated sentiment analysis system for providing an electronic dashboard for dynamically monitoring sentiment based on, inter alia, social media data and triggering mitigating efforts, in response thereto, or triggering trend augmentation efforts in response to the detection of positive trends, is provided. Persons skilled in the art will appreciate that the present invention can be practiced by other than the described embodiments, which are presented for purposes of illustration rather than of limitation. The present invention is limited only by the claims that follow.

What is claimed is:

1. A method for mitigating a negative sentiment trend, said sentiment trend being derived from a sentiment analysis, the sentiment analysis being based on aggregating communications between a first individual, group or entity and a second individual, group or entity, the method comprising:
mining social media, using one or more public Application Programming Interfaces (“APIs”), to recover a plurality of artifacts, each of said plurality of artifacts comprising a transmitting entity and a receiving entity;
for each artifact:
determining a sentiment score for the artifact, the sentiment score being based on:
natural language processing;
computational linguistics;
biometrics;
text analysis, the text analysis analyzing:
key words and phrases;
emoticons;
characters;
length of response;
response time between artifacts;
related artifacts;
negation;
exaggerations;
jokes; and/or
sarcasm;
identifying a transmitting entity of the artifact;
identifying a receiving entity of the artifact;
adding the sentiment score to an aggregated sentiment score, said aggregated sentiment score being associated with a communication link, said communication link linking the first individual, group or entity and the second individual, group or entity;
periodically updating, over a pre-determined amount of time, an aggregated sentiment score for the communication link;
identifying a negative trend in the aggregated sentiment score over the pre-determined amount of time; and
triggering, based at least in part on the identifying a negative trend, a mitigating response to the negative trend in the aggregated sentiment score.

2. The method of claim 1 wherein the mitigating response is selected from a group consisting of one or more e-mail communications to the first individual, group or entity, one or more electronic text messaging communications to the first individual, group or entity, one or more electronically-generated telephone communications to the first individual, group or entity, one or more electronically-generated chat communications to the first individual and a combination of the foregoing.

3. The method of claim 1 wherein the mitigating response is triggered in real-time following the identifying of the negative trend.

4. The method of claim 1 further comprising displaying the aggregated sentiment score on a display which corresponds to the pre-determined amount of time.

5. The method of claim 4 wherein the triggering is based at least in part on identifying the negative trend in the aggregated sentiment.

6. The method of claim 1 wherein the first individual, group or entity comprises two or more transmitting entities.

7. The method of claim 1 wherein the second individual, group or entity comprises two or more receiving entities.

8. A method for augmenting a positive sentiment trend, said sentiment trend being derived from a sentiment analysis, the sentiment analysis being based on aggregating communications between a first individual, group or entity and a second individual, group or entity, the method comprising:
mining social media, using one or more public Application Programming Interfaces (“APIs”), to recover a plurality of artifacts, each of said plurality of artifacts comprising a transmitting entity and a receiving entity;
for each artifact:
determining a sentiment score for the artifact, the sentiment score being based on:
natural language processing;
computational linguistics;
biometrics;
text analysis, the text analysis analyzing:
key words and phrases;
emoticons;
characters;
length of response;
response time between artifacts;
related artifacts;
negation;
exaggerations;
jokes; and/or
sarcasm;
identifying a transmitting entity of the artifact;
identifying a receiving entity of the artifact;
adding the sentiment score to an aggregated sentiment score, said aggregated sentiment score being associated with a communication link, said communication link linking the first individual, group or entity and the second individual, group or entity;
repeatedly generating, over a pre-determined amount of time, an aggregated sentiment score for the communication link;
identifying a positive trend in the aggregated sentiment score over the pre-determined amount of time; and
triggering, based at least in part on the identifying a positive trend, an augmenting response to the positive trend in the aggregated sentiment score.

9. The method of claim 8 wherein the mitigating response is selected from a group consisting of one or more e-mail communications to the first individual, group or entity, one or more electronic text messaging communications to the first individual, group or entity, one or more electronically-generated telephone communications to the first individual, group or entity, one or more electronically-generated chat communications to the first individual and a combination of the foregoing.

10. The method of claim 8 wherein the mitigating response is triggered in real-time following the identifying of the positive trend.

11. The method of claim 8 further comprising displaying the aggregated sentiment score on a display which corresponds to the pre-determined amount of time.

12. The method of claim 11 wherein the triggering is based at least in part on identifying the positive trend in the aggregated sentiment.

13. The method of claim 8 wherein the first individual, group or entity comprises two or more transmitting entities.

14. The method of claim 8 wherein the second individual, group or entity comprises two or more receiving entities.

15. A method for determining a negative sentiment trend, the determining comprising aggregating the sentiment analysis of communications between a plurality of individuals, groups or entities, the method comprising:
identifying two individuals, groups or entities;
identifying a communication link, the communication link for linking the two individuals, groups or entities, the communication link being associated with an individual aggregated sentiment score;
mining a plurality of artifacts, each artifact included in the plurality of artifacts being transmitted between the two individuals, groups or entities;
determining a sentiment score for each of the plurality of artifacts;
labeling each artifact with:
the sentiment score;
the individual, group or entity from which the artifact was transmitted; and
the entity to which the artifact was transmitted;
in response to receipt of each artifact, updating an aggregated sentiment score that corresponds to the communication link;
periodically updating, over a pre-determined amount of time, an aggregated sentiment score for the communication link;
identifying a negative trend in the aggregated sentiment score over the pre-determined amount of time; and
triggering, based at least in part on the identifying a negative trend, a mitigating response to the negative trend in the aggregated sentiment score.

16. The method of claim 15 wherein the mitigating response is selected from a group consisting of one or more e-mail communications to the first individual, group or entity, one or more electronic text messaging communications to the first individual, group or entity, one or more electronically-generated telephone communications to the first individual, group or entity, one or more electronically-generated chat communications to the first individual and a combination of the foregoing.

17. The method of claim 15 wherein the mitigating response is triggered in real-time following the identifying of the negative trend.

18. The method of claim 15 further comprising displaying the aggregated sentiment score on a display which corresponds to the pre-determined amount of time.

19. The method of claim 18 wherein the triggering is based at least in part on identifying the negative trend in the aggregated sentiment.

20. The method of claim 15 wherein the aggregate sentiment score is based on:
natural language processing;
computational linguistics;
biometrics; and
text analysis.

21. The method of claim 20 wherein the text analysis comprises analysis of:
key words and phrases;
emoticons;
characters;
length of response;
response time between artifacts;
related artifacts;
negation;
exaggerations;
jokes; and/or
sarcasm.

22. The method of claim 15 wherein the communication link corresponds to both the entity from which the artifact was transmitted and the entity to which the artifact was transmitted.
